(19) United States
(12) Patent Application Publication
(10) Pub. No.: US 2007/0035952 A1
(43) Pub. Date: Feb. 15, 2007

(54) Method for producing a medium for reproducing three-dimensional configurations

(76) Inventor: Felix von Laffert-Kobylinski, Bochurn (DE)

Correspondence Address: FRIEDRICH KUEFFNER, 317 MADISON AVENUE, SUITE 910, NEW YORK, NY, 10017, US

(21) Appl. No.: 10/570,192

(22) PCT Filed: Aug. 30, 2004
(86) PCT No.: PCT/DE04/01913

§ 371 Date: Feb. 28, 2006

(30) Foreign Application Priority Data
Aug. 30, 2003 (DE) 103-40-109.1

(51) Int. Cl. F21S 8/10

(52) U.S. Cl. 362/317

(57) ABSTRACT

According to a method for producing a medium for the real or virtual reproduction of three-dimensional configurations, these configurations are recorded by exposing a film, which is provided with lens arrangements, to light via the lenses. A three-dimensional image is produced by viewing the entire lens matrix arrangement and can be stationary relative to the medium depicting the image. A device serves to produce a medium for reproducing, which is produced using this method.

The invention relates to a method for producing a medium for the real or virtual reproduction of real or calculated three-dimensional configurations as well as a method for producing a medium for the real or virtual reproduction of real or calculated three-dimensional configurations.

The invention also relates to a device for producing a medium for recording and/or reproducing three-dimensional real or virtual configurations.

Three-dimensional representations having a print which is provided with a lens arrangement are known, so that the observer thus can only view the print through the lens arrangement. These lenses are usually arranged as cylinder lenses in longitudinal direction across the entire length of the medium and lead, depending on the viewing angle, to the effect that the observer with a view from different angles also observes different image information. With such an image different effects, for example a person in different positions, can obtain a three-dimensional effect or different images can be presented.

The present invention has the object to conceive a method for producing an improved three-dimensional representation with additional effect possibilities and a corresponding device, and additionally enable a simplified recording of 3D-configurations.

This object is met by means of a method in that a recording is made by exposing a film provided with lens arrangements to light via the lenses.

The medium which is produced in this way has the advantage that when viewing of the film with the corresponding lens arrangement a three-dimensional image becomes visible which is stationary relative to the medium to be depicted. A film provided with a lens arrangement according to the invention can also be a lens arrangement which is provided with a film or with a layer furnished with light-sensitive particles. An adjustment between the film and lenses is not necessary since they no longer need to be retroactively aligned toward each other, but instead are immediately recorded accordingly. Real configurations, such as for example three-dimensional images themselves, negative hollow images or 3D-configurations can be recorded in the form of data and represented on a film provided with lens arrangements with the method according to the invention. When viewing the film through the lenses a three-dimensional image becomes visible, with which completely new effects can be obtained, for example, 3D representations of objects in front of or behind an image plane with parallax information in each spatial direction, negative hollow images, recording and representation of movements and everything that can be depicted with images technically reworked on a computer or fictitious images, such as 3D-photomontage, the appearance and disappearance of objects, the display of a multitude of two-dimensional images, zoom effects or morphing effects. A combination of these effects is also possible.

It is also possible with the method according to the invention that a 3D-configuration or a negative hollow image is received. In doing so, a negative hollow image is recorded and a three-dimensional image is produced, or a 3D-configuration is recorded and a negative hollow image is produced. If a real three-dimensional configuration is received by exposing a film provided with a lens arrangement to light via the lenses and this is then developed, the film will show a negative hollow image of this 3D-configuration when viewed through its lens arrangement.

In other words, the film is a black and white or color negative based on the development and one also sees this negative in the form of a hollow image because of the lens arrangement. In the case of a hollow image, all spatial relationships are switched. Spatially, it looks as if one is viewing all objects from the inside and objects parts located further away from the observer now obscure objects which are closer. A hollow image of a hollow image is thus spatially normal again. Analogously, the term hollow image is also used in holography, wherein it refers to the image seen when viewing a transmission hologram from behind.

For the variation of the invention according to which the recording of a natural 3D-scene is carried out for a reproduction most true to the original, it is provided that in an initial process step a first film provided with lens arrangements is exposed to light and developed to a negative and that in a second process step a recording of the first film is produced by exposing a second film provided with lens arrangements to light. In this way, a three-dimensional image is effectively recorded from a first three-dimensional image. The first film is developed to a negative and is depicted by means of the lenses provided on both the films on the second film, whereupon the second film is developed to a positive and is viewed through its lens arrangement. When viewing the first film one sees all recorded objects in the form of a negative hollow image at the places which the objects had during the recording relative to the first film with the lens arrangement. A virtual or real image becomes visible through the lens arrangement on the second developed film which is located where the negative hollow image of the first recording configuration was located relative to the second recording configuration during the exposure of the second film. Three-dimensional scenes can thus be recorded in natural light or unspecific artificial light and is easy for anyone to apply.

A further preferred embodiment of the invention provides that the exposure arrangement of the individual images of a three-dimensional representation or of a negative hollow image is shown individually in succession and these are recorded by means of a repeated exposure. In this way, each enlarged calculated individual image of a 3D-representation or of a negative hollow image is shown on the screen of the exposure arrangement and depicted on the film via the lens of the exposure arrangement and the lenses of the lens arrangement.

This procedure is repeated for all lenses of the lens arrangement. In doing so, the positioning of the exposure arrangement needs to be with an accuracy of approximately 0.05 to 0.5 mm depending on the lens sizes of the lens arrangement. It is necessary to consider that an uneven brightness of the recording can result from a poor positioning; the resolution is only marginally affected thereby. A good angle resolution and alignment of the exposure arrangement is only important in this regard. However, a comparatively more precise positioning is advisable when producing a 3D-negative hollow image, especially if it concerns reproduction purposes. Unlike known printing techniques, the necessary adjustment of the print relative to the cylinder lens screen is omitted.

Furthermore, it can be provided that an electronic processing of the image data is made possible by carrying out a high-resolution image scanning of the medium side far from the lenses after the production of a negative hollow image or of a 3D-representation.

Regarding the recording of objects which are in motion, it is suggested that a changing three-dimensional configuration is recorded by means of an exposure which changes equally long.

A moving scene can be recorded in that the exposure is changed by moving an otherwise non-transparent foil with a transparent strip spaced across the film.

During the movement the transparent strip is moved along where the observer should be moving along after the completion of the recording during the representation of the scene, particularly since the relative positions are maintained during the three-dimensional representation.

A further preferred embodiment of the invention provides that a film developable from the side far from the lenses is used, or light-sensitive particles are used which are applied directly or indirectly onto the side of the medium far from the lenses.

A spatial image reversal is prevented by assigning the film provided with lens arrangements to one or more retroreflecting foil(s) and a semitransparent mirror. The use of positive developing film material is also possible and advantageously leads to the fact that a 3D positive can be immediately produced without creating a 3D-negative hollow image as an intermediate product.

The object according to the invention is also met by means of a method for producing the above mentioned device in that two or more lens layers are glued together by means of an adhesive under vacuum and/or compression.

This method enables a particularly good relative positioning of the individual lens layers. This thus guarantees a good optical quality. In addition, the lens layers are brought into optical contact and stably connected with each other in this way.

A variation of the invention provides that dividers are burned into the material by means of laser light. The simple production process is advantageous in this regard, i.e., the dividers do not have to be mechanically connected as an additional component to the lenses; instead, following the production of the lens layers, dividers can be burned into them.

A further preferred embodiment of the invention provides that aperture stops are produced by diffusion of a coloring in one or more lens layers. This method enables a simple production of an aperture stop within a lens. The construction of an aperture stop within a lens in the shape of a separate component would be much more costly to produce and therefore disadvantageous.

A precisely defined measurement of the aperture stop can only be produced, if the diffusion process does not continue any longer. This is effected by stopping the diffusion of the coloring thermally or by means of UV light.

Furthermore, it may be provided that the physical and/or chemical properties of the coloring are chosen such that it can diffuse especially well into a certain lens layer, but not as well into neighboring lens layers. Thus, it is possible to prevent that certain areas are unwontedly colored.

A further variation of the invention provides that recesses are etched into the lenses of a lens layer. This enables, for example, that pouring of an aperture stop, wherein the aperture stops would then be located entirely or partially within the lenses. Alternatively, there would also be room for the adhesive which in a limited transparent type can take up enough room in these recesses, so as to form aperture stops there.

Further advantageous embodiments of the invention provide that a transparent photographic film is glued by its base material side by means of an adhesive under vacuum and/or compression together with a lens layer and that light-sensitive particles are directly or indirectly applied to a lens layer.

The object according to the invention is also met by means of a device, wherein the device serves the recording of a medium for real or virtual reproduction with a film to be exposed, wherein the film is provided with a lens arrangement and wherein the lenses serve as an objective lens for recording and as an ocular lens for the reproduction.

This device is for example suitable for recording 3D-scenes and presenting them with limited resolution and a limited angle of vision. For this purpose, a natural 3D-scene or a calculated three-dimensional configuration is recorded on a first film with a lens arrangement. The first film is developed. While the first film is lit from behind, the second film is exposed to light and then developed. The viewer is shown a real or also virtual image which is located exactly where the negative hollow image of the first recording configuration was located relative to the second recording configuration during the second recording. This three-dimensional image is closer to the viewer by the distance between the lenses of the first and second film, than the scene to be recorded was actually located from the lenses of the first film during the first recording. An advantage of the spaced arrangement of the films is the fact that the films can be developed and fixed from behind, without having to separate the lens arrangements from the films. Image distortions are thereby avoided which could arise from the expansion of the film and from adjustment problems when assembling the developed film and lens arrangement.

A preferred embodiment of the device provides that the lenses of the lens arrangement have a quadrangular or hexagonal shape. The lenses should have a size of 0.1 to 10 mm, depending on the distance of observation. For an intended observation distance of for example 30-50 cm, the lenses should have a diameter of approximately 0.3 mm, since the viewing angle via which a lens is seen, also corresponds to the angle resolution determined by the lens diameter.

It is conceivable that the lenses are arranged in the form of a lens matrix.

Lenses with a convex focal plane can be used if the film is split into a matrix of individually curved films.

When enlarging the viewing angle there may be a so-called jumping of the image, so that the image information belonging to the neighboring lens can be seen. Analogously, the film piece located behind a lens should not receive any light via the neighboring lenses during the exposure. Thus, dividers are provided between the lenses. These should advantageously be black or another dark color and exhibit the thinnest divider wall thickness possible.

The above specified advantage of the dividers can also be attained by assigning a disk to the lenses exhibiting an incidence angle-dependent transparency which rapidly increases within a few, preferably less than 5 degrees, wherein an increase is considered for this purpose to be at least three-fold, but preferably 10-fold to 20-fold. Such a disk could for example be composed of a multitude of tubes whose axis is parallel to the disk normal.

In order to be able to see the three-dimensional image under a larger viewing angle, the focal length must be shortened relative to the lens diameter. This however decreases the angle resolution, but the size of the diffraction disk remains constant. For this reason it is suggested that gas or a fluid is provided between the lenses and the film, so that the lens can be designed as a bi-concave lens with two refracting interfaces. Air is a possible gas in this regard. Alternatively, lens systems can be deployed which effectively assume the function of a wide-angle lens.

A lens material with the highest diffraction index possible also provides for a relatively short focal length.

A further advantageous embodiment of the invention provides that aperture stops or LCD shutters are provided in the light path in order to shield possible light at the edges and to control the exposure time.

A particularly focused image is made possible in that the aperture stops are arranged completely or partially within the lenses. In this way the positioning of the aperture stops is arbitrary and provides the improved possibility to chose which circular rays of which various light refracting surfaces are shielded. This makes an optimization of the optical quality possible.

The resolution of the lens or of the objective lens is limited due to the light diffraction. This may make it sensible to have an aperture stop made of a material whose transparency level is location-dependent or that the lenses or surfaces of the lenses exhibit a graduated transparency. In this way, the diffraction rings can be reduced around the diffraction disk.

A reduction of device components leads to a more simple and inexpensive production. This can be effected in that the adhesive which glues the individual lens layers together exhibits a limited transparency, and in this way forms the aperture stops. In the places where the adhesive forms a thicker layer, it lets less light through; in the places where the adhesive forms a thinner layer, it lets more light through.

The farther the light incidence angle is distanced from the lens axis, the less light intensity arrives in the focal point on the film. An analogous process takes place during observation through the lenses. In order to balance the intensity differences, it is recommendable that a corrective layer is arranged between the lens arrangement and film, whose transparency level is location-dependent.

The corrective foil is conveniently lighter on the outside and darker on the inside, in order to be able to correct the intensity.

The lens layers exhibit precisely fitting surfaces for the purpose of an exact positioning. This make is difficult to apply the adhesive which should produce the optical contact and glue the lens layers together, as air bubble-free as possible between the lens layers in the production. A simple insertion of the adhesive is made possible in that inlet ducts are left open within or partially within the lens layers.

The invention stands out especially in that a method for the production of a medium for reproducing three-dimensional real or virtual configurations and a device created for this purpose which enables the viewing of a three-dimensional image, which generally is stationary relative to the medium to be represented.

A film provided with lens arrangements is exposed to light in order to make a recording of what is either represented by a first film, a similarly made film or an object or another three-dimensional configuration, also in the form of calculated image data shown by means of the exposure arrangement. A three-dimensional recording is created in the process with completely new effect possibilities which were not possible with previously known methods.

Further details and advantages of the invention are shown in the description of the drawings, in which a preferred embodiment is illustrated with all the necessary details and individual components, as follows:

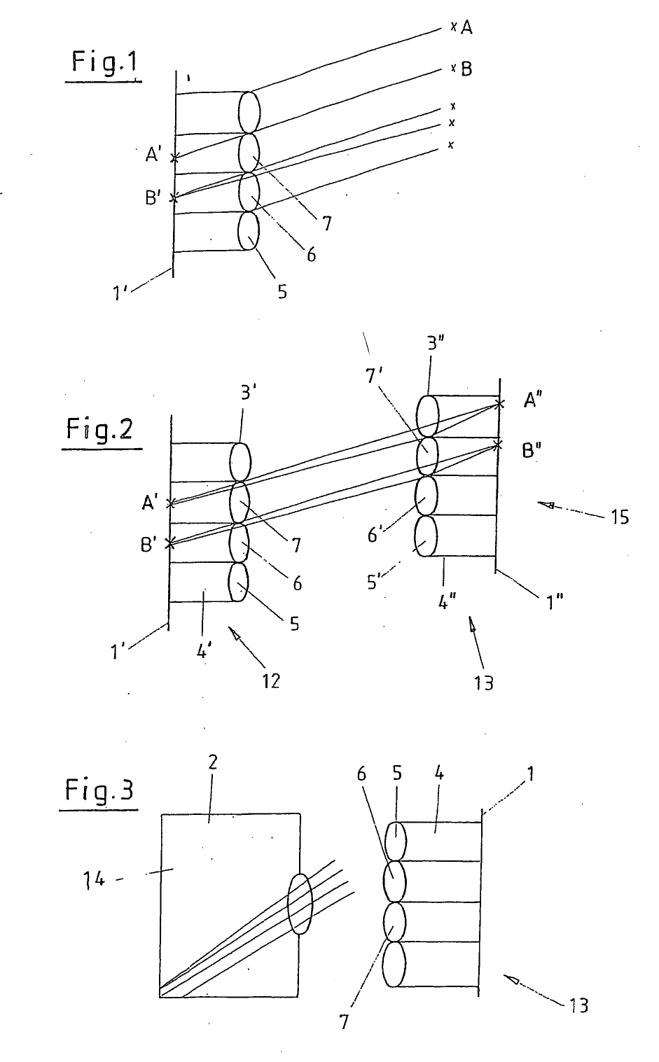

FIG. 1 shows the exposure of the first film;

FIG. 2 shows the exposure of the second film during the recording of a 3D representation,

FIG. 3 shows the exposure of a film by means of an exposure arrangement which shows calculated image data,

FIG. 4 shows a film with a lens arrangement,

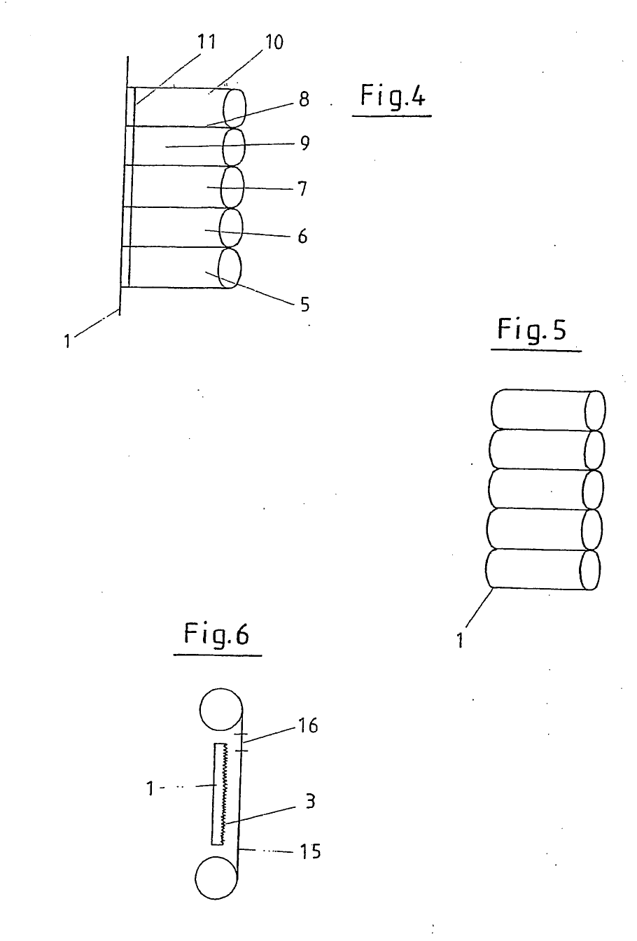

FIG. 5 shows a curve-shaped film,

FIG. 6 shows a device for recording moving images,

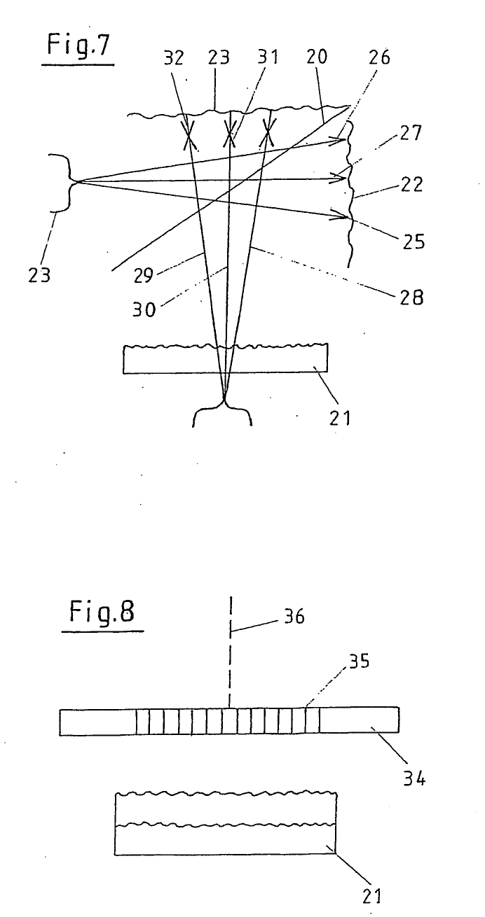

FIG. 7 shows an arrangement with reflector foils and mirror, and

FIG. 8 shows an arrangement with a disk with incidence angle-dependent transparency.

FIG. 1 effectively shows the first work step of the method according to the invention. Objects A, B are thereby recorded and projected onto the film 1′ via the lenses 5, 6, 7. After the exposure the film 1′ is developed as a negative. When looking at the negative, one can see all the recorded objects A, B at places which these had during the recording relative to the film 1′ including the lens arrangement 5, 6, 7. However, one can only see the surfaces and surface information facing the film 1′ such that objects closer to the film obscure those farther from the film.

The next process step, the exposure of second film 1″, is described in FIG. 2. Film 1′, the exposure arrangement 2 is thereby exposed from behind, film 1″ is exposed and developed, without having to first separate it from the lenses 5′, 6′, 7′. In doing so, the points A′ are reproduced on A″ and B′ on B″. The film 1″ is then observed through the lenses 5′, 6′, 7′, wherein a virtual and/or real image becomes visible which is located exactly where the real image of the first recording configuration 12 was located relative to the second recording configuration 13 during the second recording. The reproduction medium, namely the film 1′ is also provided with a lens arrangement 3′ as the film 1″ is provided with a lens arrangement 3″. The lens arrangement 3′, 3″ are arranged at the sides 4′, 4″ facing each other.

In FIG. 3 the recording of the image data displayed by means of the exposure arrangement 2 is shown with the help of a screen 14. The enlarged, calculated individual image of a three-dimensional photograph or of a negative hollow image is shown on the screen 14. This is located in the focal plane of a lens with a preferably identical diameter as the lenses of the recording arrangement 13 and is projected through the lens to infinity. In this way, what is seen through an individual lens of a recording which was produced with a film provided with a lens arrangement is simulated. The recording configuration 13 is exposed therewith. The exposure arrangement 2 is moved of a lens diameter, the accordingly calculated, neighboring individual image is shown on the screen 14 and it is exposed to light again. The procedure is repeated for all individual images.

FIG. 4 shows a film 1 with additional features, namely a divider 8 which is provided for preventing the “jumping” of the image. In addition, gas or fluid is shown with the reference numeral 9 which leads to a second refracting lens surface and thus shortens the focal length of the lens. The corrective layer is denoted with 11 which serves to correct the light intensity and is composed of a location-dependent, transparent foil. Finally, the aperture stop 10 can be seen which can shield unwanted light at the edges.

In FIG. 5 it is shown that the film 1 can also be curved in order to be able to use lenses with a convex focal plane.

Moving images can be recorded with a device according to FIG. 6. The exposure is thereby changed during the movement, preferably by moving a transparent strip 16 in an otherwise non-transparent foil 15 during the movement along where the observer should move along during the representation of the scene.

FIG. 7 shows the arrangement with a mirror 20, whose arrangement prevents a spatial image reversal by assigning the film provided with lens arrangements in this embodiment to two retroreflector foils 22, 23 and a semitransparent mirror 20. In this way a 3D-positive of the exposure arrangement 23 can be produced directly in the form of the film 21, without creating a 3D-negative hollow image as an intermediate product. The light rays 25, 26, 27 or 28, 29, 30 are reflected on the retroreflectors 22, 23 or on the semitransparent mirror 20 in the process, which is shown by means of arrows 31, 32.

Finally, FIG. 8 shows the disk 34 with tubes 35 functioning as dividers as well as the 3D-film. The disk 34 exhibits an incidence angle-dependent transparency which increases rapidly within a few degrees. The axes 35 of the tubes 35 extend parallel to the disk normal 36.

A further embodiment shall be illustrated as follows:

During the selection of lens sizes it should be taken into account that each lens for every observation direction which it is able to depict, should represent a pixel of the 3D-image. The upper limit of the angle resolution is determined by two mechanisms:

The angle alpha via which a lens, i.e. a pixel, can be seen, is approximately determined by the following formula:
alpha−sin(alpha)=D/B
wherein:

D is the diameter of the lenses of the lens arrangement

B is the intended observation distance

The lens opening diffracts the light and creates a diffraction disk on the film. The thereby resulting smallest possible resolvable angle (epsilon) is rendered by the following formula:
Epsilon=1.22*Lambda/D
Wherein:

D is the diameter of the lenses of the lens arrangement

1.22 is the prefactor for circular lenses

The smallest resolvable angle resulting from both of these processes is produced when alpha=epsilon, and thus the optimal lens diameter follows from the intended observation distance.
Alpha=Epsilon<=>D/B=1.22*Lambda/D <=>D*D=B*1.22*Lambda

Several lens sizes calculated in this way are shown for an average light wavelength of 600 nM in the following table.

| Observation | | Resolvable Angle in |
|---|---|---|
| Distance in cm | Lens Diameter in mm | rad |
| 30 | 0.47 | 0.00156 |
| 60 | 0.66 | 0.00108 |
| 120 | 0.94 | 0.00078 |
| 240 | 1.33 | 0.00054 |
| 480 | 1.87 | 0.00039 |
| 980 | 2.65 | 0.00027 |

When selecting the film resolution it should be taken into account that the distance of two resolvable points on a film results from
s=f*epsilon
wherein:

epsilon is the smallest resolvable angle

f is the focal length of the lens

All mentioned characteristics, alone and in combination, including those which can only be seen in the drawings are considered quintessential to the invention.

1. A device for recording and/or reproducing three-dimensional real or virtual configurations having a film to be exposed, wherein the film is provided with a lens arrangement and wherein the lenses serve as objective lenses for recording and as ocular lenses for reproducing, wherein aperture stops or LCD-shutters are provided in the light path of the lenses.

2. The device according to claim 1, wherein the aperture stops are arranged completely or partially within the lenses.

3. The device according to claim 1, wherein the aperture stop is made of a material whose transparency level is location-dependent or that the lenses or surfaces of the lenses exhibit a graduated transparency.

4. The device according to claim 3, wherein the aperture stops comprise a coloring which is diffused in one or more lens layers.

5. The device according to claim 4, wherein the aperture stops comprise a coloring which is diffused in one or more layers, whose diffusion is stopped thermally or by means of UV light.

6. The device according to claim 4, wherein the aperture stops comprise a coloring which is diffused in one or more lens layers, which was chosen such that it could diffuse especially well into a specific lens layer.

7. The device according to claim 2, wherein recesses are present in the lenses of a lens layer which were etched.

8. The device according to claim 1, wherein the adhesive which glues individual lens layers together exhibits a limited transparency and thus forms aperture stops.

9. The device according to claim 1, characterized in that wherein dividers are provided between the lenses.

10. The device according to claim 1, wherein a disk is assigned to the lenses which exhibits an incidence angle-dependent transparency that increases rapidly within a few degrees.

11. The device according to claim 1, wherein inlet ducts within or partially within the lens layers are left open for an adhesive.

12. The device according to claim 1, wherein the film is split into a matrix of separately curved films.

13. A method according to claim 1, wherein one or more retroreflector foil(s) and/or a semitransparent mirror is assigned to the film provided with lens arrangements.

14. A method for producing a device according to claim 1, wherein two or more lens layers are glued together by means of adhesive under vacuum and/or compression, with the limitation that, two or more lenses which are located on an optical axis thereby form an achromatic lens or an apochromatic.

15. A method for producing a medium for the real or virtual reproduction of real or calculated three-dimensional configurations, wherein a recording is made by exposing a film provided with lens arrangements to light via lenses, wherein the exposure is carried out by moving an otherwise non-transparent foil with a transparent strip spaced across the film.

16. The method according to claim 15, wherein a changing three-dimensional configuration is recorded by means of an exposure which changes equally long.

17-30. (canceled)
